(19) United States
(12) Patent Application Publication
(10) Pub. No.: US 2013/0325897 A1
(43) Pub. Date: Dec. 5, 2013

(54) SYSTEM AND METHODS FOR PROVIDING CONTENT

(71) Applicants: Nitin Motgi, Santa Clara, CA (US); Masood Mortazavi, San Jose, CA (US); Bruno Fernandez-Ruiz, Mountain View, CA (US)

(72) Inventors: Nitin Motgi, Santa Clara, CA (US); Masood Mortazavi, San Jose, CA (US); Bruno Fernandez-Ruiz, Mountain View, CA (US)

(73) Assignee: YAHOO! INC., Sunnyvale, CA (US)

(21) Appl. No.: 13/483,175

(22) Filed: May 30, 2012

(51) Int. Cl. G06F 17/30

(52) U.S. Cl. 707/776; 707/758; 707/E17.014; 707/E17.032

(57) ABSTRACT

Method, system, and programs for generating questions for a user. A request for content from a user is received via the communication platform. The content is retrieved from a content source. A question is generated for the user based on the content requested by the user and a history of previous information accessed or posted by the user. The question is sent to the user.

### BACKGROUND

1. Technical Field

The present teaching relates to methods, systems, and programming for collecting information about a user and the user's interests. More particularly, the teaching relates to generating questions for the user and gathering the answers to those questions.

2. Discussion of Technical Background

Social networking sites and news sites on the Internet attract hundreds of millions of users every month. The popularity of such sites depends on many factors. One factor is the ease-of-use of the site, which corresponds to the ability of a user to navigate the site and find information and content relevant to the user. Another factor is the ability of the site to present or suggest content relevant to the user that the user did not search for. The more users a site has, the more potential the site has to generate revenue.

Companies and advertisers attempt to predict the interests of users. These predictions are used to place targeted advertisements in front of users, and to customize the users' experience with the website. The better the predictions of the interests of the users, the better will be the aid provided by the website to the users. Thus, the users will have a better experience with the website and the website will become more popular and generate more revenue. Poor predictions of the interests of the users cause frustration to the users and may cause the users to visit a different website.

### SUMMARY

The teachings disclosed herein relate to methods, systems, and programming for identifying interests of users. More particularly, the present teaching relates to methods, systems, and programming for generating questions for a user and gathering the answers to those questions.

In one example, a method, implemented on a machine having at least one processor, storage, and a communication platform connected to a network for generating questions, is disclosed. A request for content from a user is received via the communication platform. The content is retrieved from a content source. A question is generated for the user based on the content requested by the user and a history of previous information accessed or posted by the user. The question is sent to the user.

In another example, a method, implemented on a machine having at least one processor, storage, and a communication platform connected to a network for generating questions, is disclosed. A request for a question from a service provider is received via the communication platform. The request includes an identity of a user and content associated with the user. The question is generated for the user based on the content associated with the user and a history of previous information accessed or posted by the user. The question is sent to the service provider.

In a different example, a method, implemented on a machine having at least one processor, storage, and a communication platform connected to a network for generating questions, is disclosed. A request for a question from a service provider is received, via the communication platform. The request includes an identity of a user and content associated with the user. The question is generated for the user based on the content associated with the user and a history of previous information accessed or posted by the user. The question is sent to the user.

In yet another example, a method, implemented on a machine having at least one processor, storage, and a communication platform connected to a network for a search engine, is disclosed. A request for content from a user is received via the communication platform. A question is generated for the user based on the content associated with the user and a history of previous information accessed or posted by the user. The question is sent to a service provider of the user.

In a different example, a system for a service provider is disclosed. The system comprises a content server, a user interest database, a content topic database, and a question generator. The content server serves content based on requests for content. The user interest database stores topics of interest to users. The content topic database stores topics for corresponding pieces of stored content. The question generator generates questions for the users based on a request from the content server, and based on the content of the user interest database and the content topic database.

Other concepts relate to software for generating questions for the user. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine-readable tangible and non-transitory medium with information recorded thereon, is disclosed. The information, when read by a machine, causes the machine to receive, via a communication platform, a request for content from a user. The information causes the machine to retrieve the content. The information causes the machine to generate a question for the user based on the content requested by the user and a history of previous information accessed or posted by the user. The information causes the machine to send, via the communication platform, the question to the user.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a question embedded in a web page according to an embodiment of the present teaching;

FIG. 2 illustrates a question in a popup from a web page according to an embodiment of the present teaching;

FIG. 3 illustrates a system for generating questions, according to an embodiment of the present teaching;

FIG. 4 illustrates a system for generating questions, according to an embodiment of the present teaching;

FIG. 5 illustrates a system for generating questions, according to an embodiment of the present teaching;

FIG. 6 illustrates a question constructor, according to an embodiment of the present teaching;

FIG. 7 is a flowchart of an exemplary process for a user to respond to a question, according to an embodiment of the present teaching;

FIG. 8 is a flowchart of an exemplary process for providing content with an embedded question according to an embodiment of the present teaching;

FIG. 9 is a flowchart of an exemplary process for recording an answer to a question sent to the user according to an embodiment of the present teaching;

FIG. 10 is a flowchart of an exemplary process for generating a question according to an embodiment of the present teaching;

FIG. 11 is a flowchart of an exemplary process for mining and recording user interests according to an embodiment of the present teaching;

FIG. 12 is a flowchart of an exemplary process for retrieving content according to an embodiment of the present teaching;

FIG. 13 is a flowchart of an exemplary process for mining content according to an embodiment of the present teaching; and

FIG. 14 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Asking users of a web site direct questions regarding the user's interests can be an effective method to gather explicit information about a user's interests. Users are not generally interested in answering questions unless there is a reward or obvious benefit to answering the questions. For example, most users will by-pass an online user survey if the users are able. Further, if a website poses too many questions to the user, the user may become irritated and leave the website. If, however, a question is posed while a user is engaged in a particular activity and the question is related to that activity, the user may provide an answer to the question without feeling irritated. Such a question may be regarded by the user as similar to a question asked by a friend during a conversation. Asking an appropriate question at the appropriate moment is important to ensuring that a good proportion of such questions will be answered by the user. Further, the questions should be chosen so that the answers, when given, provide information regarding the interests and needs of the user.

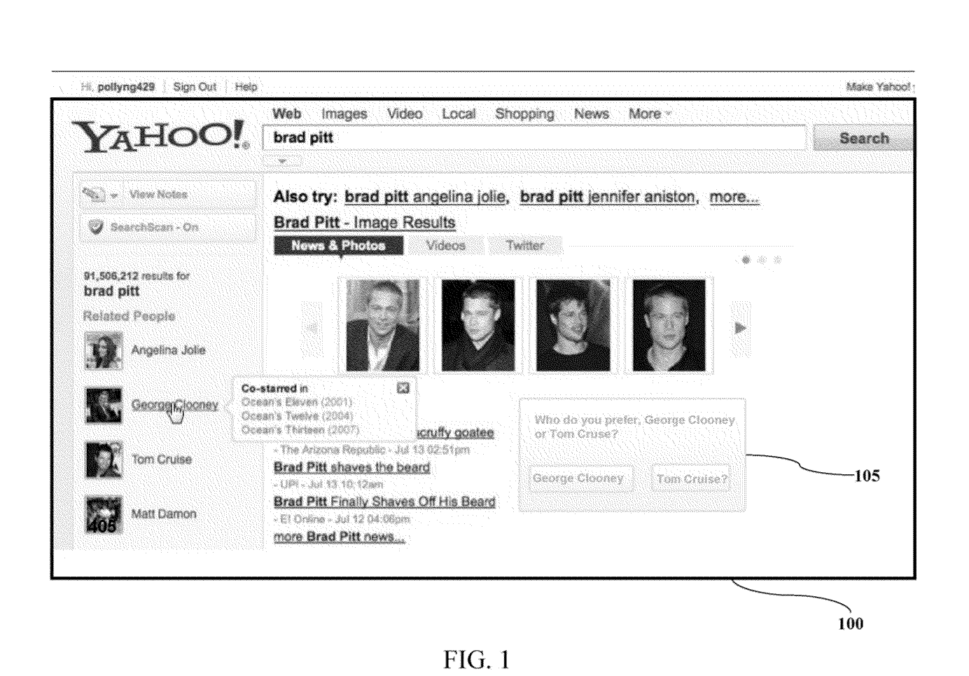

FIG. 1 illustrates a webpage that incorporates a question 105. The webpage is a result of a search for “Brad Pitt.” Based on the search request, a website returned a web page that features Brad Pitt. Incorporated into the page is the question 105. The question is incorporated into the page by a web server that provided the webpage. A question generator generated the question, based on information known about the user that searched for Brad Pitt, and the topics in the webpage that features Brad Pitt. In this particular example, the question generator noted that the user has an interest in Brad Pitt based on previous web browsing. Further, the question generator noted that the user has an interest in Tom Cruise also based on previous web browsing. However, although there is a relation between Brad Pitt and George Clooney, the question generator noted that there is no information recorded regarding whether the user is interested in George Clooney. Therefore, the question generator posed the question, “do you prefer George Clooney or Tom Cruise?” to discover the user's opinion regarding George Clooney. If the user indicates that they prefer George Clooney, it can be recorded in the user interests that the user is interested in George Clooney because it is already known the user is interested in Tom Cruise. If the user indicates they preferred Torn Cruise, it can be recorded that George Clooney is less interesting to the user than Tom Cruise.

The question 105 is embedded in the webpage, so the user is not required to provide an answer in order to continue browsing. If the user chooses to answer the question, then, in some embodiments, the question is removed from the webpage so that the user may continue browsing that webpage. In some embodiments, if the question 105 is answered, a subsequent question may be posed by the question generator and placed on the webpage 100. In some embodiments, if the question 105 is answered, the user may be taken to a different webpage depending on the answer given.

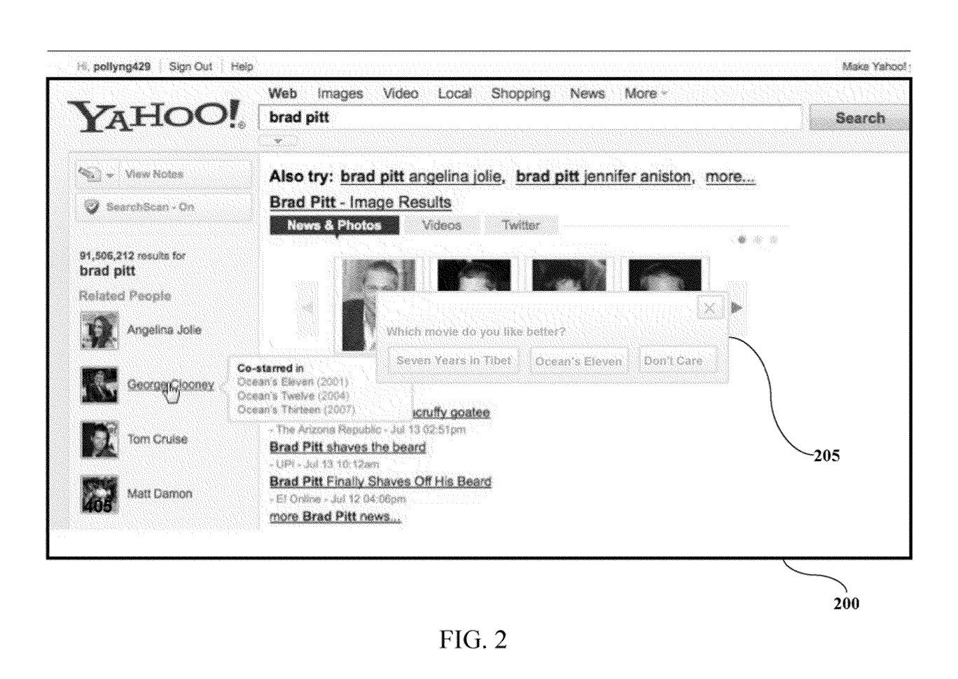

FIG. 2 illustrates a webpage 200. The webpage 200 is also the result of the search for “Brad Pitt.” Question 205 is placed as a pop-up over the webpage 200. In order to continue browsing the user is required to answer question 205. Question 205 is, thus, more intrusive than question 105. The question generator noted that the user is interested in Brad Pitt. Further, the question generator noted that the user is known to be interested in all of the topics on webpage 200. However, the question generator noted that the user indicated that they liked the movie seven years in Tibet, but has not indicated any opinion about the movie Oceans Eleven. Therefore, the question generator posed the question which movie do you like better, to determine the users interest in the movie Oceans Eleven.

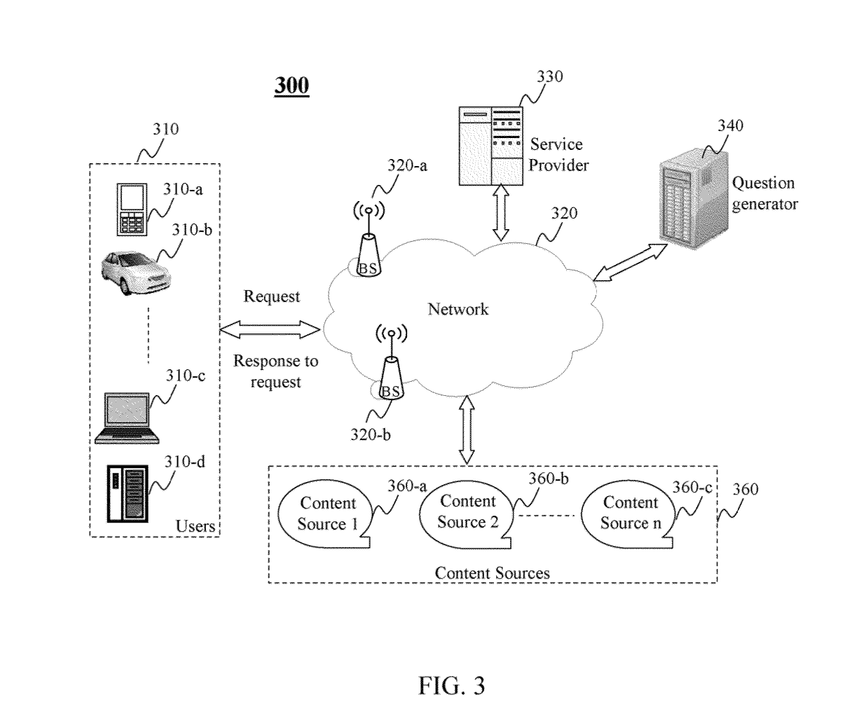

FIG. 3 is a high-level depiction of an exemplary system 300, in which a question generator 340 for generating questions is deployed, according to a first embodiment of the present disclosure. The exemplary system 300 includes users 310, a network 320, a service provider 330, content sources 360, and the question generator 340. The network 320 in system 300 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. A network may also include various network access points, e.g., wired or wireless access points such as base stations or Internet exchange points 320-a, . . . , 320-b. Using the wired or wireless access points a data source may connect to the network 320 in order to transmit information via the network 320.

Users 310 may be of different types such as users connected to the network via desktop connections (310-d), users connected to the network via wireless connections such as through a laptop (310-c), a handheld device (310-a), or a built-in device in a motor vehicle (310-b). A user may send a request to the service provider 330 via the network 320 and receive a request result from the service provider 330 through the network 320. The request result may be provided directly by the service provider 330, or obtained by the service provider 330 from any one of a number of content sources 360. The content sources 360 include multiple content sources 360-a, 360-b, . . . , 360-c. A content source may correspond to a web page host corresponding to an entity. The web page host may be an individual, a business, or an organization such as USPTO.gov, a content provider such as cnn.com and Yahoo.com, or a content feed source such as tweeter or blogs. The requests and request results are also sent to the network 320 and are directed to the question generator 340. The question generator 340 generates questions for the user. Both the service provider 330 and the question generator 340 may access information from any of the content sources 360-a, 360-b, . . . , 360-c. The service provider 330 may rely on such information to respond to a request (e.g., the service provider 330 provides web content corresponding to the request and returns the web content to a user). The question generator 340 may rely on content sources 360-a, 360-b, . . . , 360-c to collect interactions of users with information available on the network 320.

In the exemplary system 300, a user may initially send a request for a web page from the service provider 330. The request and the response to the request are sent to the question generator 340. The question generator 340 generates questions based on the request, the response to the request, and known information about the user. In some embodiments, the question generator 340 returns the question to the user 310 via the network 320. In some embodiments, the question generator 340 sends the question to the service provider 330. The service provider 330 incorporates the question into the response to the request, and returns the response to the user 310.

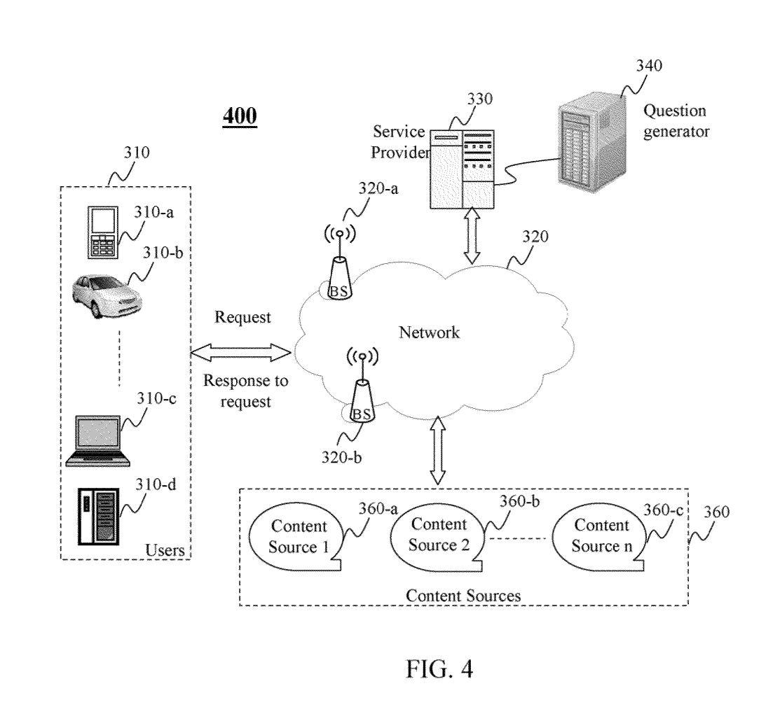

FIG. 4 is a high-level depiction of an exemplary system 400 in which a question generator 340 is deployed to provide questions, according to a second embodiment of the present teaching. In this embodiment, the question generator 340 serves as a backend system of the service provider 330. The request is sent to the service provider 330, which then invokes the question generator 340 to provide the question. The service provider 330 incorporates the question into the response to the request and sends the response to the user.

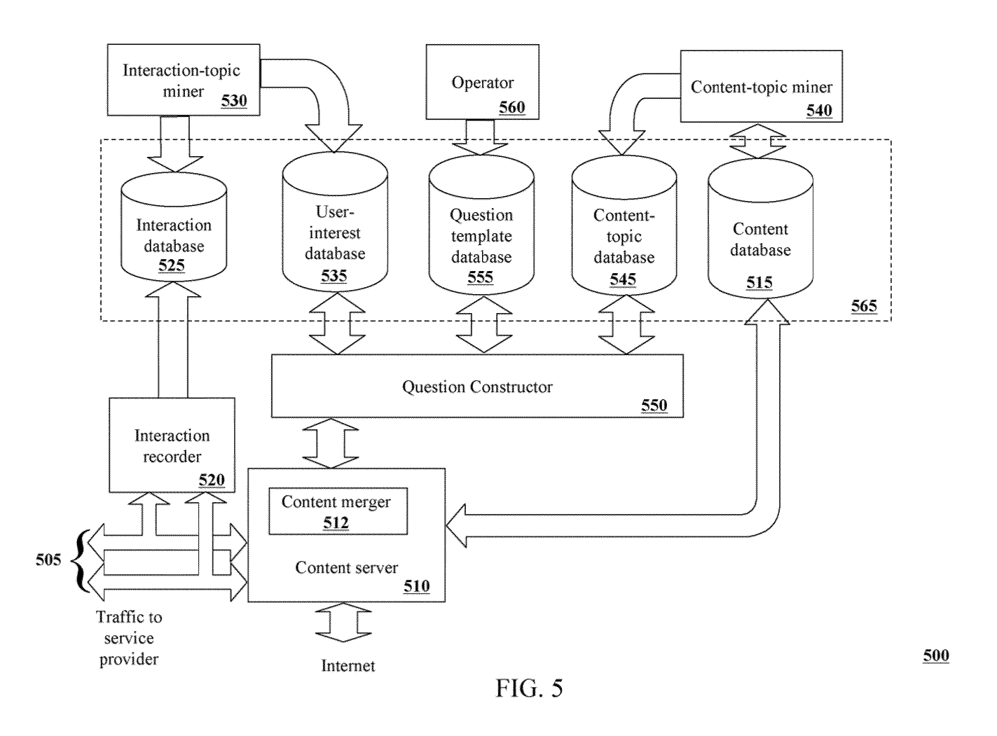

FIG. 5 depicts a system 500 for generating questions, according to an embodiment of the present teaching. The system 500 comprises elements for delivering, storing, and finding topics in content, the elements including a content server 510, a content database 515, a content-topic miner 540, and a content-topic database 545. The content server 510 is connected to a network 505. In some embodiments, the content server 510 is connected to the Internet. The content database 515 is connected to the content server 510. The content-topic miner 540 is connected to the content database 515, and the content-topic database 545 is connected to the content-topic miner 540.

The system 500 further comprises elements for recording the interactions of users and finding topics that users are interested in, the elements including an interaction recorder 520, an interaction database 525, an interaction-topic miner 530, and a user-interest database 535. The interaction recorder 520 is connected to the network 505 and the interaction database 525. The interaction database 525 is connected to the interaction-topic miner 530. The interaction-topic miner is connected to the user-interest database 535.

The system 500 further comprises elements for generating questions, including a question constructor 550 and a question template database 555. The question constructor 550 is connected to the content server 510, the user-interest database 535, the content-topic database 545, and the question template database 555. The question template database 555 is connected to an operator 560.

The content database 515, the interaction database 525, the user-interest database 535, the question template database 555, and the content-topic database 545 may be separate databases or portions of a database 565, as shown in FIG. 5.

The content server 510 receives requests from a user attached to network 505. The network 505 may be the Internet, a private network, a wireless network, a cellular network, or any other computer network. The user may be directly attached to the network 505 or attached via a separate network to the network 505. The interaction recorder 520 records the request in the interaction database 525. The content server 510 processes the request from the user to determine content that the user is requesting. Based on the content requested the content server 510 searches the content database 515 to find the content. If the content server 510 finds the content in the content database 515, then the content server retrieves the content from the content database 515. In some embodiments, if the content server 510 does not find the content in the content database 515, then the content server sends a message to the user indicating that the content could not be found. In some embodiments, if the content server 510 does not find the content in the content database 515, the content server 510 requests content from the Internet. If the content is found on the Internet, the content server retrieves the content from the Internet. If the content is not found on the Internet, the content server sends a message to the user indicating that the content could not be found. The content server 510 may also search other networks for the content, and if the content is found, retrieve the content.

If the content server 510 successfully retrieves the content, the content server 510 requests a question from the question constructor 550. The question constructor 550 delivers the requested question to the content server 510 and the content server 510 merges the content and the question into merged content. The content server 510 comprises a content merger 512 for merging the retrieved content and the requested question.

The content server 510 delivers the merged content to the user via the network 505. The interaction recorder 520 records the delivered merged content in the interaction database 525. In some embodiments, if the question constructor 550 cannot construct a question, the content server 510 delivers the content without the question to the user via the network 505. The interaction recorder 520 stores the content in the interaction database 525.

The interaction recorder 520 collects interactions between users on the network 505 and the content server 510, including requests for content, delivered content, and any additional interactions such as cookies exchanged between the content server 510 and the users. In some embodiments, the content server 510 and the interaction recorder 520 are merged into a single unit that performs the functions of the content server 510 and the interaction recorder 520. The interaction recorder 520 collects, for example, requests for content and content sent in response to the requests, e-mails sent or received, instant messages sent or received, text messages sent or received, blog postings, etc. The interaction recorder 520 stores the interactions in the interaction database 525. In some embodiments, the interaction recorder 520 filters the interactions to be stored in the interaction database 525 to remove unnecessary interactions. Unnecessary interactions include, for example, messages indicating that content is not available, other error messages generated by the content server 510, and streaming data, such as audio or video content.

The interaction-topic miner 530 mines the interaction database 525 to find topics of interest to the users, based on content requested by the users. In some embodiments, the interaction-topic miner 530 finds relationships between the topics and characterizes the topics. Thus, for example, the interaction-topic miner 530 characterizes topics corresponding to the names of people as people, the names of places as places etc. The relationships between the topics may include, for example, that the following people are all actors, the following places are in California eta. The interaction-topic miner 530 may use any of a number of statistical techniques and rules to determine topics of interest to each user. The statistical techniques include, for example, latent Dirichlet allocation, hierarchical Dirichlet processes, or probabilistic latent semantic analysis. Rules may include, for example, assuming that proper nouns in documents requested by a user correspond to a topic that a user is interested in. The interaction-topic miner 530 stores the user interests determined in the user-interest database 535.

The content-topic miner 540 mines the content database 515 to find topics associated with each piece of content stored in the content database 515. In some embodiments, the content-topic miner 540 finds relationships between the topics, and characterizes the topics. Thus, for example, the content-topic miner 540 characterizes topics corresponding to the names of people as people, the names of places as places etc. The relationships between the topics may include, for example, that the following people are all actors, the following places are in California etc. Content-topic miner 540 may use any other number of statistical techniques and rules to determine the topics contained in each piece of content in a similar manner to that for the interaction-topic miner 530. The content-topic miner 540 stores the topics corresponding to each piece of content in the content-topic database 545.

In some embodiments, the interaction-topic miner 530 and the content-topic miner 540 are combined into a single topic miner that works simultaneously on interaction database 525 and content database 515. In some embodiments, the interaction database 525 and content database 515 comprise a single database that the combined topic miners 530, 540 mine for topics.

The question template database 555 contains templates for forming questions. The templates contain the text of questions with positions marked to insert topics. For example, the template for question 105 (FIG. 1) may comprise “Who do you prefer, [person 1] or [person 2]? In the example of question 105, [person 1] is replaced by the topic George Clooney and [person 2] is replaced by the topic Tom Cruise. In some embodiments, any topic can be inserted in the position marked. In some embodiments, only a topic of the appropriate type can be inserted in the positions marked. In some embodiments, the topic miners 530, 540 indicate the type of topic for interest topics and content topics stored in the databases 515, 525. Thus, for example, George Clooney and Tom Cruise would both be indicated as people in the databases 515, 525.

The templates for the questions in the question template database 555 are provided by an operator 560. The question constructor 550 constructs questions and outputs the questions as question content. The question constructor 550 constructs questions based on information stored in the user-interest database 535, the content-topic database 545, and the question template database 555.

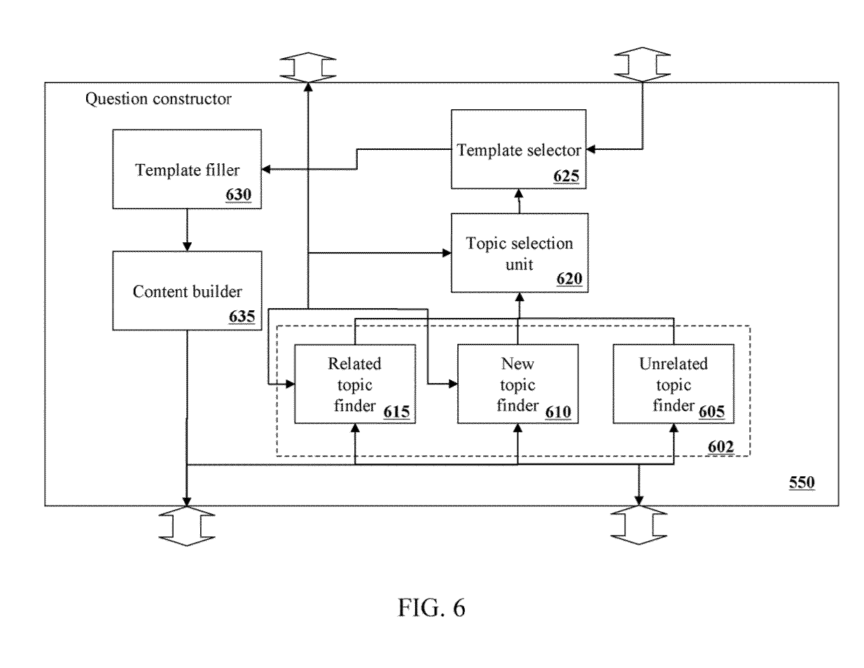

FIG. 6 depicts the question constructor 550, according to an embodiment of the present teaching. The question constructor 550 comprises a set of one or more topic finder units 602, a topic selector 620, a template selector 625, a template filler 630, and a content builder 635.

The topic finder units 602 find possible topics for inclusion in a question. In FIG. 6, three topic finders are illustrated. Each topic finder is dedicated to finding a particular relationship between topics, users, and content. When the question constructor receives a request for a question from, for example, content server 510, the identity of the user, and the identity of the content requested are sent to the topic finder units 602. Upon receiving the identity of the user and the identity of the content requested, each of the topic finders in the set of topic finder units 602 queries the user interest database 535 and the content-topic database 545 to retrieve topics found for the user and the topics found for the content. Each of the topic finders in the set of topic finder units 602 uses a set of predetermined rules to search for topics that may form useful questions. For example, unrelated topic finder 605 reviews the topics listed for the content and searches for pairs of topics that are not recorded in the content-topic database as being related or closely related. For example, a news item in 2010 indicated that extracts from a flower known as Baby's Breath help cure Leukemia. The content-topic miner 540 may have recorded that Baby's Breath and leukemia are only related by this news item. If the information is recorded regarding the user's interest in either of the topic words, then the unrelated topic finder selects Baby's Breath and leukemia because asking the user reading this item a question related to Baby's Breath and leukemia may indicate whether the user is more interested in the flower Baby's Breath or leukemia. The question constructor may construct a question like, “Are you more interested in Baby's Breath or leukemia?” The unrelated topic finder therefore, searches the topics in the content for pairs of topics that are not closely related and compiles a list of such pairs of topics for the content requested by the user. The unrelated topic finder 605 indicates that no information is known regarding the interests of the user in either of each pair of topic words. As in the example discussed above, a topic word may comprise more than one word as in “Baby's Breath.” A topic word may also be a phrase or a sentence.

The new topic finder 610 compiles a list of topics in the content requested by the user for which no information is known about the interests of the user. This list of topics allows questions to be asked regarding topics that the user has never seen before. Regarding the above article, the user may never have viewed a document with Baby's Breath before this document. The question constructor may construct a question like, for example, “Do flowers like Baby's Breath interest you?” New topic Finder 610 indicates that no information is known regarding the interests of the user in each of the topic words.

The related topic finder compiles a list of topics in the content requested for which no information is known regarding the interest of the user, but which are strongly related to other topics that the user has indicated as being of interest. For example, the webpage 100 comprises the names of actors. If, for example, it is not known whether the user is interested in Matt Damon, but Matt Damon is strongly related to Tom Cruise, and Tom Cruise is indicated as being of interest to the user, then the related topic finder would add Matt Damon and Tom Cruise to the list of possible topics for which a question can be constructed. The related topic finder 615 indicates that Tom Cruise and Matt Damon form a pair of topic words for a question. The related topic finder 615 further indicates that no information is known regarding the interests of the user in Matt Damon.

The unrelated topic finder 605, new topic finder 610, and related topic finder 615 are merely examples, and any topic finder unit with suitable rules for finding topics for questions is within the scope of this disclosure.

The topic finder units 602 sends lists of topic words for questions to a topic selector 620. The topic selector 620 selects the most valuable topic word from the list of topic words for which no information is known regarding the interests of the user. The most valuable topic word is selected based on predetermined rules. Examples of the predetermined rules include 1) selecting the topic that is most common in the content database 515, 2) selecting the topic that has been the most popular topic for other users, in the last week, or month or year, and 3) selecting a topic that is most strongly connected to other topics known to be of interest to the user. The above rules are merely examples, and any rule or combination of rules compatible with embodiments of this disclosure, is within the scope of this disclosure.

The topic selector sends the selected topic words to the template selector. The template selector 625 selects a question template based on the number of topic words that are associated with the selected topic word, and the number of those words for which the interest of the user is unknown. In some embodiments, if more than one template is acceptable the template selector 625 may randomly select a question template from the acceptable templates. In some embodiments, the template selector 625 uses a predetermined set of rules to determine the best template from the acceptable templates.

Templates are selected from the question template database 555. The templates in the question template database 555 are constructed by the operator 560. During operation, the operator may review topic words selected by the topic selector 620. Based on this review, the operator may add question templates suitable for the topic words in the review.

The template selector 625 sends the selected question template and the selected topic words to a template filler 630. The template filler 630 then places the topic words in the appropriate locations in the question template. The template filler 630 sends the filled template to the content builder 635.

The content builder 635 builds a graphical representation of the filled template. The graphical representation may be formed, for example, as HTML or XML. The graphical representation may also be formed as JavaScript, PHP code, Java code, or any other suitable representation compatible with embodiments of the disclosure. The graphical representation may include, for example, buttons for a user to respond to the question in the graphical representation. The graphical representation may include fields for the user to enter an answer to the question in the graphical representation. The graphical representation may be capable of responding to gestures or voice commands for the user to answer the question in the graphical representation.

When the graphical representation of the filled template is complete, the question constructor 550 sends the graphical representation to the entity that requested the question.

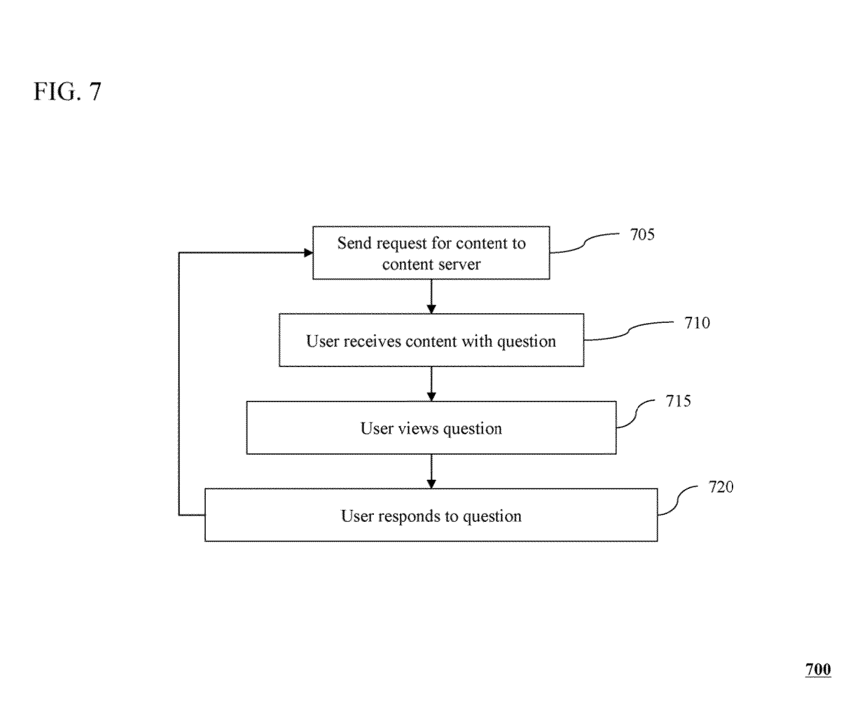

FIG. 7 is a flowchart of an exemplary process 700 for a user to respond to a question, according to an embodiment of the present teaching. The process begins at step 705. At step 705, the user sends a request for content to a content server 510.

At step 710, the user receives the requested content with an embedded question. At step 715, the user views the question embedded in the content. At step 720, the user response to the question by, for example, clicking on a button in the embedded question. In some embodiments, the question may be responded to using a voice-recognition system in a device of the user displaying the requested content. In some embodiments, the question may be responded to by using a gesture on a touch screen of the device of the user. When the user has responded to the question, the method repeats starting from step 705.

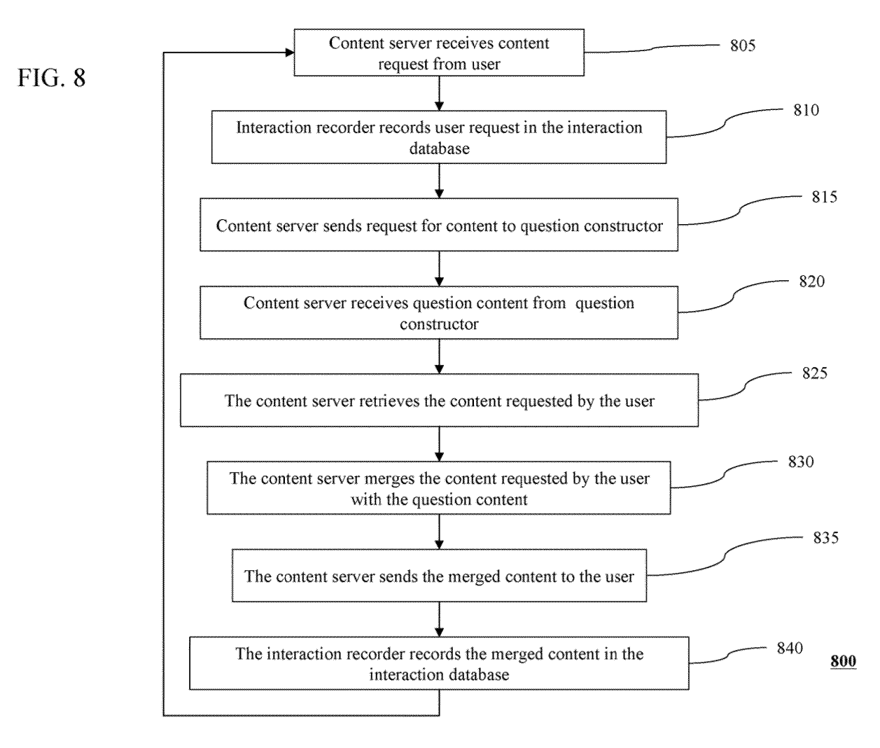

FIG. 8 is a flowchart of an exemplary process 800 for providing content with an embedded question according to an embodiment of this teaching.

The process begins at step 805. At step 805 the content server 510, receives a content request from a user. In some embodiments, the content server 510 receives the content request from another service provider. In some embodiments, the content request from another service provider includes an identity of the user.

At step 810, an interaction recorder 520 records the user request, in interaction database 525. As noted above, interaction recorder 520 records interactions, including requests for content and content sent in response to the requests, e-mails sent or received, instant messages, sent or received, text messages, sent or received, blog postings, etc. In some embodiments, the interaction recorder 520 is located in the same machine as the content server 510. In some embodiments, the interaction recorder 520 is located in the same machine as the content server 510. In some embodiments, the interaction recorder 520 is located on a different portion of the Internet, or a different portion of a computer network from the content server 510.

At step 815, the content server 510 sends the request for content to the question constructor 550. In some embodiments, the question constructor 550 is located in the same machine as the content server 510. In some embodiments, the question constructor 550 is located in the same machine as the content server 510. In some embodiments, the question constructor 550 is accessible by the content server 510 via the Internet or another computer network. In some embodiments, the requested content sent to the question constructor 550 includes an identity of the user requesting the content.

At step 820, the content server 510 receives question content from the question constructor 550, the question based on information stored in the interaction database 525, information stored in the content database 515, and information stored in the question template database 555.

At step 825, the content server 510 retrieves the content requested by the user. In some embodiments, the content server 510 retrieves the content requested by the user from the content database 515. In some embodiments, the content server 510 retrieves the content requested by the user from stores of content on another network. In some embodiments, the content server 510 retrieves the content requested by the user from the Internet.

At step 830, the content server 510 merges the content requested by the user with the question content to form a merged content using the content merger 512. In some embodiments, the question content is formed as an integral part of the content requested by the user. In some embodiments, the question content is separate from but tied to the content requested by the user, for example, as a popup for the content. In some embodiments, the question content includes possible answers to the question. In some embodiments, the question content includes buttons or other means for the user to respond to the questions in the question content.

At step 835, the content server 510 sends the merged content to the user. In some embodiments, the content server 510 sends the merged content to a service provider, and the service provider sends the content to the user.

At step 840, the interaction recorder 520 records the merged content in the interaction database 525 and the process repeats from step 805 for the next request for content.

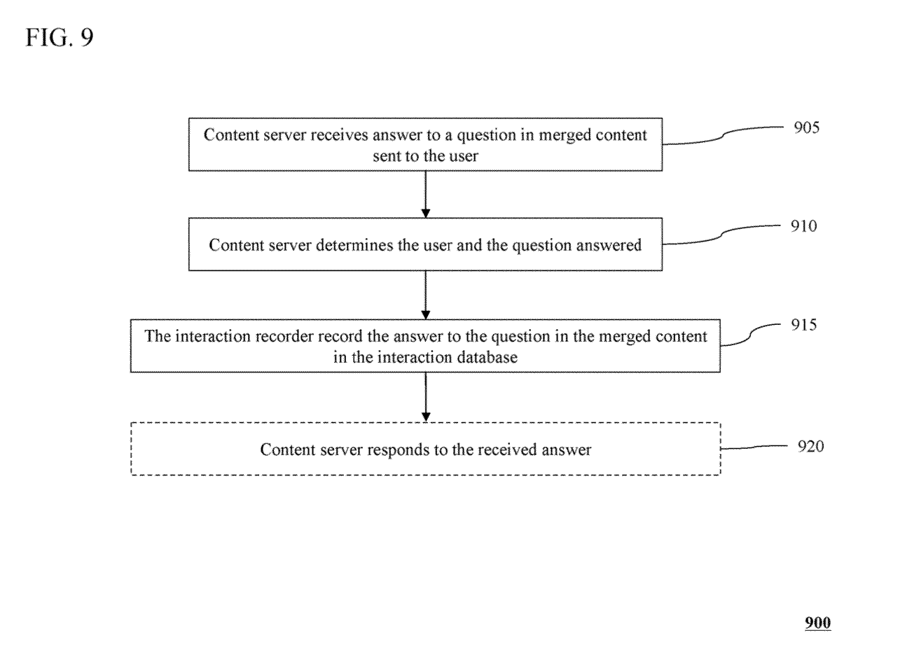

FIG. 9 is a flowchart of an exemplary process 900 for recording an answer to a question sent to the user according to an embodiment of this teaching.

At step 905, the content server 510 receives an answer to the question in merged content sent to the user. In some embodiments, the received answer to the question includes the question. In some embodiments, the received answer to the question does not include the question and the content receiver retrieves the question based on the identity of the user, or a cookie sent by the user. In some embodiments, the interaction recorder 520 receives the answer to the question in the merged content.

At step 910, the content server 510 determines the user and the question answered by the user. In some embodiments, the interaction recorder 520 determines the user and the question answered.

At step 915, the interaction recorder 520 records the answer to the question in the merged content in the interaction database 525.

At step 920, which is optional, the content server 510 may respond to the received answer. For example, if the question embedded in the content was “Would you like to know more about the Grand Canyon?” The content server 510 may respond immediately with content corresponding to the Grand Canyon. In some embodiments, the content May be displayed for the user in a new browser window, a new tab in a browser window, an e-mail, instant message, a pop-up box, or any other method of providing the content to the user that responded to a question in the merged content.

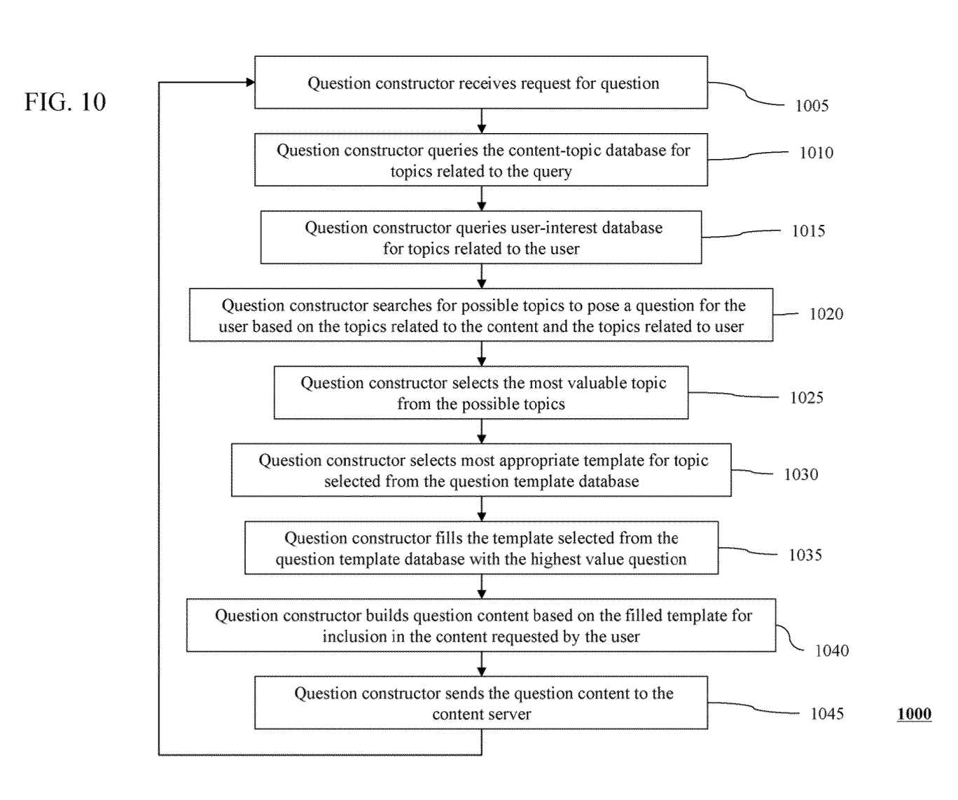

FIG. 10 is a flowchart of an exemplary process 1000 for generating a question according to an embodiment of this teaching. The process 1000 corresponds to steps 815 and 825 in FIG. 8. Process 1000 may be executed by question constructor 550 in response to a request for a question from content server 510. At step 1005, the question constructor 550 receives a request for a question. In some embodiments, the request for the question includes an identity of a user that requested content, and the identity of the content requested.

At step 1010, the question constructor 550 queries a content-topic database 545 for topics related to the content requested by the user.

At step 1015, the question constructor 550 queries, the user-interest database 535, for topics related to the user.

At step 1020, the question constructor 550 searches the possible questions to pose to the user based on topics related to the content and the topics related to the user. The searches can be based on sets of predetermined rules as described above for topic finder units 602. The question constructor 550 builds a list of possible topics about which to ask questions. As described above, in some embodiments, the topics may include one or more topic words, with an indication noting whether any information is known regarding the interests of the user in each topic word.

At step 1025, the question constructor selects the most valuable topic from the possible topics. As noted above, the most valuable topic is selected based on predetermined rules. Examples of the predetermined rules include 1) selecting the topic that is most common in the content database 515, 2) selecting the topic that has been the most popular topic for other users, in the last week, or month or year, and 3) selecting a topic that is most strongly connected to other topics known to be of interest to the user. The above rules are merely examples, and any rule compatible with embodiments of this disclosure is within the scope of this disclosure.

At step 1030, the question constructor 550 selects the most appropriate template for the selected topic from the question template database 555. As noted above, in some embodiments, the question constructor 550 uses the type of information in the topic words to select appropriate question templates. For example, if the topic words correspond to people, the question constructor 550 selects, templates that have fields that correspond to people. If the topic words correspond to locations, the question constructor 550 selects templates that correspond to locations. In some embodiments, if more than one template is available, the question constructor 550 selects the template randomly from the available templates. In some embodiments, the question constructor 550 selects the template based on predetermined rules.

At step 1035, the question constructor 550 fills the template selected from the question template database with the topic words for the most valuable topic.

At step 1040, the question constructor 550 builds question content based on the fill template. Specifically, the question constructor 550 builds a graphical representation of the filled template. The graphical representation may be formed, for example, as HTML or XML. Further, the graphical representation may be formed as JavaScript, PHP code, Java code, or any other suitable representation compatible with embodiments of the disclosure. The graphical representation may include, for example, buttons for user to respond to the question in the graphical representation. The graphical representation may include fields for user to enter an answer to the question in the graphical representation. The graphical representation may be capable of responding to gestures or voice commands for the user to answer the question in the graphical representation.

At step 1045, the question constructor 550 sends the question content to the entity that requested the question.

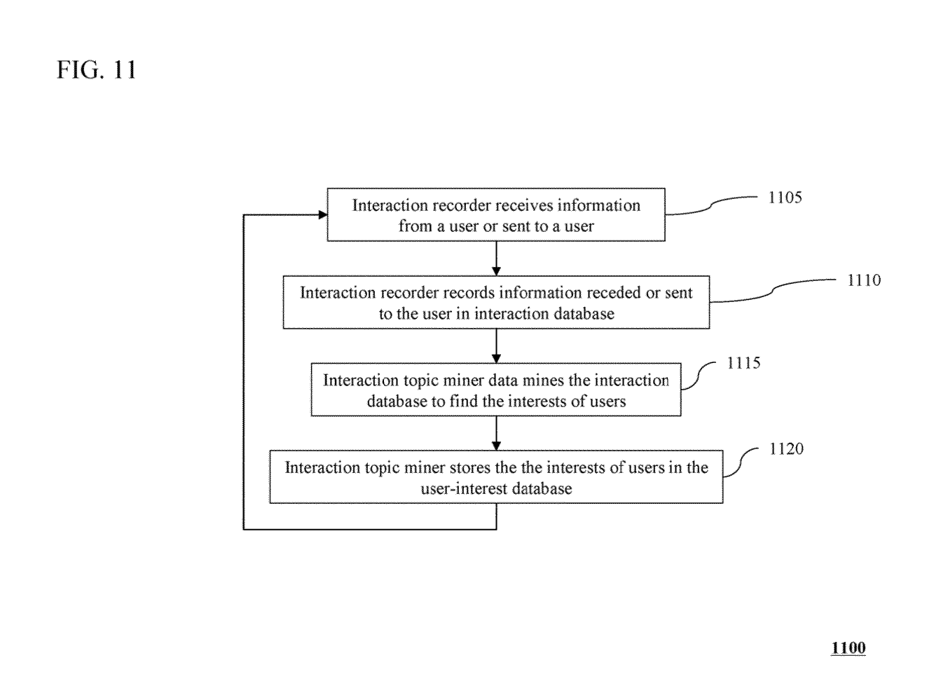

FIG. 11 is a flowchart of an exemplary process 1100 for mining and recording user interests according to an embodiment of this teaching. At step 1105, the interaction recorder 520 receives information from a user or information sent to a user.

At step 1110, the interaction recorder 520 records information received from or sent to the user in the interaction database 525.

At step 1115, the interaction-topic miner 530 data mines the interaction database 525 to find the interests of the users.

At step 1120, the interaction-topic miner stores interests of the users in the user-interest database 535. When the interests of users are stored, the process repeats from step 1105. In some embodiments, the data mining process is not triggered by an update to the interaction database 525, but is scheduled to occur at a predetermined time or after a predetermined interval. In some embodiments, the data mining process is initiated by an operator. If the interaction-topic miner is only requested when a new interaction is added to the interaction database 525, the interaction-topic miner is prevented from performing unnecessary work.

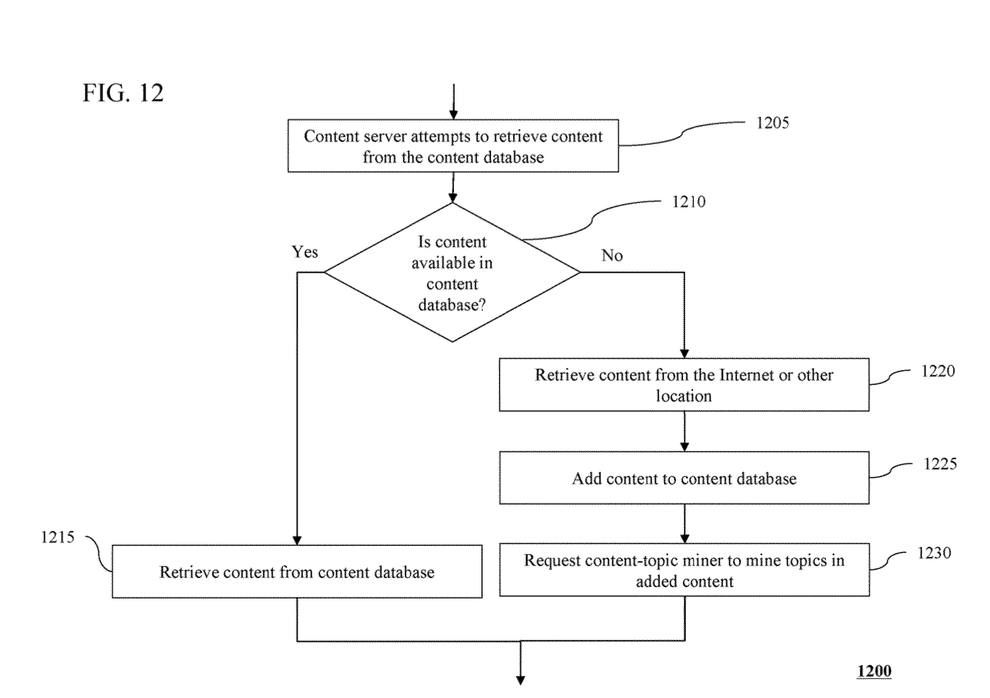

FIG. 12 is a flowchart of an exemplary process 1200 for retrieving content according to an embodiment of this teaching. The processes in process 1200 correspond to a more detailed description of step 825 in FIG. 8 in which a content server retrieves content. At step 1205, the content server 510 attempts to retrieve content from the content database 515

At step 1210, the content server 510 determines whether the content is available in the content database 515. If the content is available in the content database 515, then the process proceeds to step 1215. If the content is not available in the content database 515, then the process proceeds to step 1220.

At step 1215, the content server 510 retrieves the content from the content database 515.

At step 1220, the content server 510 retrieves the content from the Internet or another location.

At step 1225, the content server 510 saves the content retrieved to the content database 515. Adding the retrieved content to the content database 515 allows the content-topic miner 540 to mine topics in the added content on the next occasion that the content-topic miner 540 is invoked.

At step 1230, the content server 510 places a request with the content-topic miner 540 to mine topics in the added content. In some embodiments, the content server 510 does not provide the request to the content-topic miner 540. In some embodiments, the content-topic miner 540 is scheduled to run at predetermined times or predetermined intervals. In some embodiments, the content-topic miner 540 is initiated by an operator. If the content-topic miner 540 is only requested when new content is added to the content database 515, the content-topic miner 540 is prevented from performing unnecessary work.

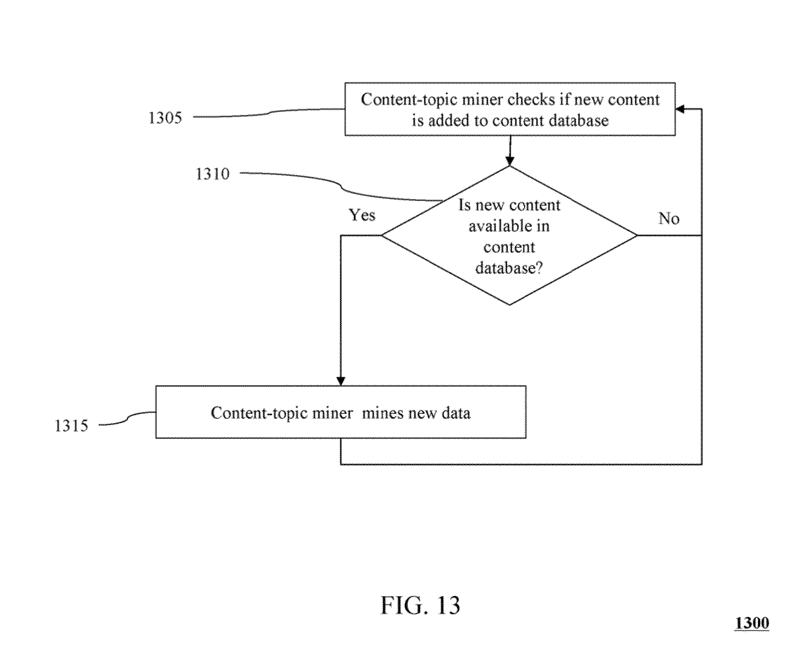

FIG. 13 is a flowchart of an exemplary process 1300 for mining content according to an embodiment of this teaching. The content mining process mines the content in the content database 515 to find topics associated with each piece of content in the content database 515.

At step 1305, the content-topic miner 540, checks whether new content is added to the content database 515. In some embodiments, as noted above, the topic miner checks to see whether topic mining is scheduled to be performed at the present time.

At step 1310, if new content is available in the content database 515, then the method proceeds to step 1315. If new content is not available in the content database 515, the method repeats the process from step 1305.

At step 1315, the content-topic miner 540 mines the new content in the content of the database. When the data mining is complete, the process repeats from step 1305.

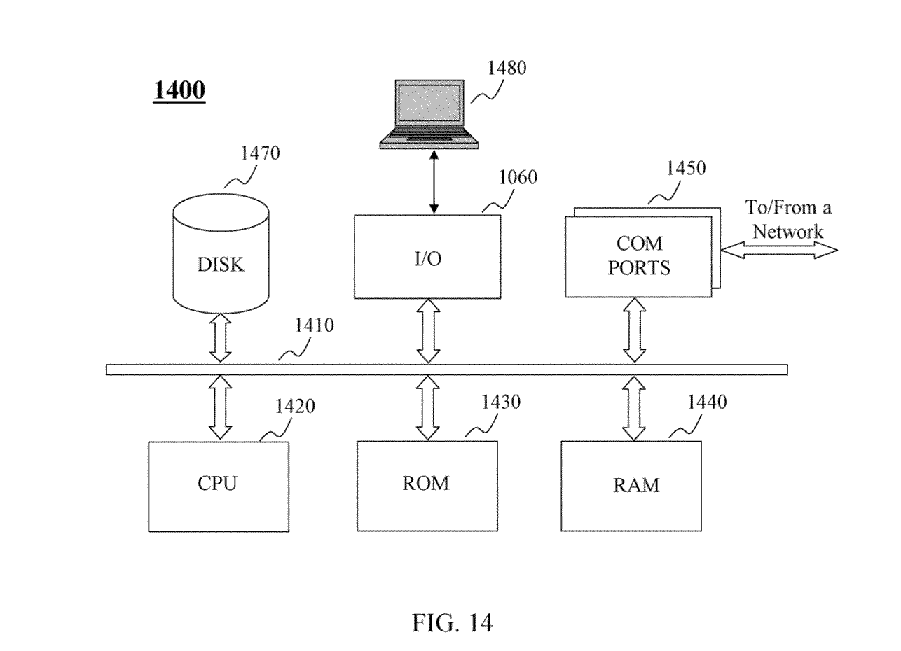

FIG. 14 depicts a general computer architecture on which the present teaching can be implemented and has a functional block diagram illustration of a computer hardware platform that includes user interface elements. The computer may be a general-purpose computer or a special purpose computer. This computer 1400 can be used to implement any components of the question generator as described herein. For example, the question generator 340, and the components of the question generator, content server 510, interaction recorder 520, Interaction-topic miner 530, content-topic miner 540, and question constructor 550, can all be implemented on a computer such as computer 1400, via its hardware, software program, firmware, or a combination thereof. Although only one such computer is shown, for convenience, the computer functions relating to question generation may be implemented in a distributed fashion on a number of similar platforms, to distribute the processing load.

The computer 1400, for example, includes COM ports 1450 connected to and from a network connected thereto to facilitate data communications. The computer 1400 also includes a central processing unit (CPU) 1420, in the form of one or more processors, for executing program instructions. The exemplary computer platform includes an internal communication bus 1410, program storage and data storage of different forms, e.g., disk 1470, read only memory (ROM) 1430, or random access memory (RAM) 1440, for various data files to be processed and/or communicated by the computer, as well as possibly program instructions to be executed by the CPU. The computer 1400 also includes an I/O component 1460, supporting input/output flows between the computer and other components therein such as user interface elements 1480. The computer 1400 may also receive programming and data via network communications.

Hence, aspects of the methods of generating questions, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of the service provider or other service providers into the hardware platform(s) of a computing environment or other system implementing a computing environment or similar functionalities in connection with generating questions. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium, or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables, copper wire, and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media, therefore, include, for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, systems and their components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform connected to a network for generating questions, comprising the steps of:
receiving, via the communication platform, a request for content from a user;
retrieving, the content from a content storage;
obtaining a question for the user based on the content requested by the user and information associated with the user; and
sending the question to the user.

2. The method according to claim 1, wherein the information associated with the user includes a history of information previously accessed or posted by the user.

3. The method according to claim 2, further comprising:
mining the history of information previously accessed or posted by the user, for topics the user is interested in; and
selecting one or more topics for the question from among the topics the user is interested in.

4. The method according to claim 3, further comprising:
mining the content storage for topics corresponding to each piece of stored content; and
selecting the one or more topics for the question based on the mined topics for the content requested by the user.

5. The method according to claim 3, further comprising:
selecting a question template from a template database, based on the selected topics; and
filling the question template with the selected topics to form the question.

6. The method according to claim 1, further comprising:
formatting the question to be displayed to the user together with the content requested;
merging the formatted question with the content requested by the user to form merged content; and
sending the merged content to the user.

7. The method according to claim 1, further comprising:
receiving, via the communication platform, an answer to the question from the user; and
storing the answer to the question as a portion of the information associated with the user.

8. A method, implemented on a machine having at least one processor, storage, and a communication platform connected to a network for generating a question, comprising the steps of:
receiving, via the communication platform, a request for a question, including an identity of a user and content associated with the user;
generating, the question for the user based on the content associated with the user and information associated with the user; and
sending the question as a response to the request.

9. The method according to claim 8, wherein the information associated with the user includes a history of information previously accessed or posted by the user.

10. The method according to claim 8, further comprising:
formatting the question to be displayed to the user;
merging the formatted question with the content requested by the user to form merged content; and
sending the merged content as a response to the request.

11. The method according to claim 8, further comprising:
receiving, via the communication platform, an answer to the question from the user; and
storing the answer to the question as a portion of the information associated with the user.

12. A method, implemented on a machine having at least one processor, storage, and a communication platform connected to a network for generating a question, comprising the steps of:
receiving, via the communication platform, a request for a question from a service provider, including an identity of a user and content associated with the user;
obtaining, the question for the user based on the content associated with the user and information associated with the user; and
sending the question to the user.

13. A method, implemented on a machine having at least one processor, storage, and a communication platform connected to a network for a search engine, comprising the steps of:
receiving, via the communication platform, a request for content from a user;
obtaining a question for the user based on the content associated with the user and a history of previous information accessed or posted by the user; and
sending the question to a service provider of the user.

14. A system for a service provider, comprising:
a content server that servers content based on requests for content;
a user interest database that stores topics of interest to users;
a content topic database that stores topics for corresponding pieces of stored content; and
a question generator that generates questions for the users based on a request from the content server, and on the content of the user interest database and the content topic database.

15. The system according to claim 14, the question generator further comprising one or more topic finders, the one or more topic finders connected to the user interest database and the content topic database, the one or more topic finders finding first topics corresponding to content requested by the users and interests for a user for which no information exists in the user interest database.

16. The system according to claim 15, further comprising:
an interaction database that stores interactions of the users with the content server; and
the question generator further comprising a topic selector that selects second topics from among the first topics found by the one or more topic finders, based on information stored in the content database and the contents of the interaction database.

17. The system according to claim 16, further comprising:
a question template database that stores one or more question templates for the questions for the users; and
the question generator further comprising a template selector connected to the question template database, the template selector selecting a one of the one or more question templates based on the second topics selected by the topic selector.

18. The system according to claim 17, the question generator further comprising:
a template filler that fills the selected question template with the second topics to form a filled template; and
a content builder that converts the filled template to form a graphical representation of the question, and sends the graphical representation of the question to the content server.

19. The system according to claim 18, the content server further comprising a content merger that merges the graphical representation of the question with the content for the request for content into a merged content to be sent to the user.

20. A machine-readable tangible and non-transitory-medium with information recorded thereon, wherein the information, when read by a machine, causes the machine to perform the following steps:
receiving, via a communication platform, a request for content from a user;
retrieving the content;
obtaining a question for the user based on the content requested by the user and information associated with the user; and
sending, via the communication platform, the question to the user.

21. The machine-readable medium of claim 20, further causing the machine to perform the following steps:
formatting the question to be displayed in a browser of the user;
merging the formatted question with the content requested by the user to form merged content; and
sending, via the communication platform, the merged content to the user.

22. The machine-readable medium of claim 20, further causing the machine to perform the following steps:
receiving, via the communication platform, an answer to the question from the user; and
storing the answer to the question as a portion of the information associated with the user.
